(19) United States
(12) Patent Application Publication
(10) Pub. No.: US 2025/0214464 A1
(43) Pub. Date: Jul. 3, 2025

(54) QUICK CONNECT CHARGING APPARATUS FOR ELECTRIC VEHICLES

(71) Applicant: Alain Jayson Laforest, Ocala, FL (US)

(72) Inventor: Alain Jayson Laforest, Ocala, FL (US)

(21) Appl. No.: 18/982,894

(22) Filed: Dec. 16, 2024

Related U.S. Application Data
(60) Provisional application No. 63/615,887, filed on Dec. 29, 2023.

(51) Int. Cl. B60L 53/16; B60L 53/18

(52) U.S. Cl. CPC B60L 53/16; B60L 53/18

(57) ABSTRACT

A quick connect vehicle charging system includes a charging cable and a vehicle charging connector having a plug and a controller that are connected to the first end of the charging cable. A first adapter having a plug, a wire and a terminal connects to the second end the charging wire to supply high voltage power from the dryer outlet to the vehicle charging connector. A second adapter having a circuit breaker, a wire and a terminal connects to the second end of the charging wire to supply high voltage power from the breaker box to the vehicle charging connector to perform level 2 vehicle charging. A third power adapter having an AC pullout switch, a wire and a terminal connects to the second end of the charging wire to supply high voltage power from the disconnect box to the vehicle charging connector to perform level 2 vehicle charging.

### CROSS-REFERENCE TO RELATED APPLICATIONS

This application claims the benefit of U.S. Application Ser. No. 63/615,887 filed on Dec. 29, 2023, the contents of which are incorporated herein by reference.

### TECHNICAL FIELD

The present invention relates generally to charging systems for electric vehicles, and more particularly to a quick connect charging system for an electric vehicle.

### BACKGROUND

The statements in this section merely provide background information related to the present disclosure and may not constitute prior art.

Due to advances in battery capacity and production techniques, many consumers are choosing to purchase electric vehicles over their gasoline counterparts. Indeed, choosing an electric vehicle has many advantages over gasoline engines such as noise reduction, lower operating costs, lack of harmful emissions and so forth. However, one drawback is the need and/or ability to find suitable charging stations.

Although most commercially available electric vehicles are provided with a charging cable that can be plugged into a standard 110v electrical outlet (referred to as level 1 charging), the time it takes to charge the vehicles' batteries can easily take up to 35-50 hours. As such, most vehicle owners must purchase dedicated high voltage fast charging systems (referred to as level 2 charging) that are hard wired into their home's electrical service panel. These high voltage systems typically pull 220v-240v and between 30-50 amps from the service panel and are able to charge the vehicle in 5-10 hours. Although useful, these level 2 systems are extremely expensive and require a skilled electrician to install, which further increases the price to obtain and use.

Unfortunately, an even greater issue arises when the vehicle owner needs to charge their vehicle when traveling, as there is a notable deficiency in the number of commercially available charging stations (compared to petrol stations) from which consumers can charge their vehicles. To this end, it is not uncommon for users to be unable to find a suitable charging station enroute, and unless their final destination has a compatible charging station, they must wait hours to charge the vehicle using the standard level 1 (110v) plug before being able to leave.

Accordingly, it would be beneficial to provide a quick connect charging system that can be configured by a user to directly engage a high voltage device of a building to conduct high voltage level 2 fast charging of an electric vehicle when no charging station is present.

### SUMMARY OF THE INVENTION

The present invention is directed to a quick connect vehicle charging system. One embodiment of the present invention can include an elongated charging cable having a pair of quick connect terminals along the proximal and distal ends. In one embodiment, a vehicle charging connector can be secured onto the charging cable by the first terminal. The vehicle charging connector can include a plug that is shaped and sized to engage the charging port of an electric vehicle, and a controller for controlling the power supplied to the vehicle via the plug.

At least one power adapter can be provided with the system to engage a high-power device of a home or building. In one embodiment, one of the power adapters can include a dryer plug adapter having a plug for engaging an electric dryer outlet. A wire extends from the plug to a quick connect terminal that connects to one of the terminals on the charging wire to supply high voltage power from the dryer outlet to the vehicle charging connector to perform level 2 vehicle charging.

In one embodiment, one of the power adapters can include a breaker box adapter having a circuit breaker for engaging a breaker box of a building. A wire extends from the circuit breaker to a quick connect terminal that connects to one of the terminals on the charging wire to supply high voltage power from the breaker box to the vehicle charging connector to perform level 2 vehicle charging.

In one embodiment, one of the power adapters can include an AC power adapter having an AC pullout disconnect switch for engaging an AC disconnect box. A wire extends from the switch to a quick connect terminal that connects to one of the terminals on the charging wire to supply high voltage power from the disconnect box to the vehicle charging connector to perform level 2 vehicle charging.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is an exploded parts view of a quick connect vehicle charging system that is useful for understanding the inventive concepts disclosed herein.

FIG. 2 is a front view of a vehicle charging connector of the quick connect vehicle charging system, in accordance with one embodiment of the invention.

FIG. 3 is a perspective view of a dryer outlet power adapter of the quick connect vehicle charging system, in accordance with one embodiment of the invention.

FIG. 4 is a perspective view of a breaker box power adapter of the quick connect vehicle charging system, in accordance with one embodiment of the invention.

FIG. 5 is a perspective view of an AC pullout switch power adapter of the quick connect vehicle charging system, in accordance with one embodiment of the invention.

FIG. 6 is a perspective view of the quick connect vehicle charging system in operation, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

### Definitions

As described herein, a “unit” means a series of identified physical components which are linked together and/or function together to perform a specified function.

As described throughout this document, the term “about” “approximately” “substantially” and “generally” shall be used interchangeably to describe a feature, shape, or measurement of a component within a tolerance such as, for example, manufacturing tolerances, measurement tolerances or the like.

As described herein, the term “removably secured,” and derivatives thereof shall be used to describe a situation wherein two or more objects are joined together in a non-permanent manner so as to allow the same objects to be repeatedly joined and separated.

As described throughout this document, the term “complementary shape,” and “complementary dimension,” shall be used to describe a shape and size of a component that is identical to, or substantially identical to the shape and size of another identified component within a tolerance such as, for example, manufacturing tolerances, measurement tolerances or the like.

As described herein, the term “high voltage” and derivatives thereof refers to at least 220 volts and 30 amps in order to permit level 2 high voltage charging of a vehicle connected to the system components.

As described herein, the term “high voltage device” and derivatives thereof refer to any component, appliance, panel, outlet, or other such mechanism that can be engaged by the system components to receive high voltage power for use in charging an electric vehicle.

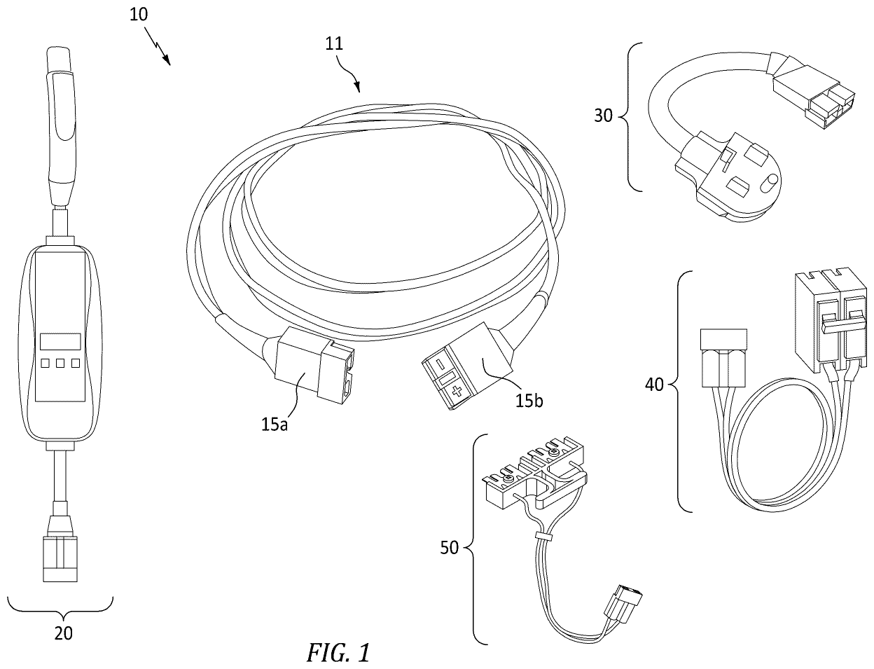

FIGS. 1-6 illustrate one embodiment of a quick connect charging system 10 for electric vehicles that are useful for understanding the inventive concepts disclosed herein. In each of the drawings, identical reference numerals are used for like elements of the invention or elements of like function. For the sake of clarity, only those reference numerals are shown in the individual figures which are necessary for the description of the respective figure.

FIG. 1 is an exploded parts view illustrating one embodiment of the system 10 that includes a charging cable 11, a vehicle charging connector 20, and a plurality of power interface devices 30, 40 and 50 to permit a user to engage and receive power from any number of high voltage devices for charging an electric vehicle when no charging station is present.

As shown, the cable 11 can include an elongated wire cable body having quick connect terminals 15a and 15b along each end. The cable 11 may be manufactured in any number of different lengths such as 20′, 40′, 50′ or 100′, for example, so as to be able to connect a vehicle to a high voltage device component or panel within a building.

As described herein, the charging cable 11 and all other cables described throughout this document (e.g., 23, 24, 32, 46 and 54) can each include any number of different types of wire cables that are suitable for receiving and conducting an electrical current from one terminal to another other. In the preferred embodiment, the cables can include two pure copper wires that are each electrically insulated by a heavy-duty non-conductive heat-resistant PVC sheath that is capable that is rated for at least 240v at 50 amps. Of course, any number of other wire types, insulation types, construction materials, voltage and/or amperages are contemplated.

The terminals 15a and 15b can be positioned along the ends of the cable 11 and can each function to removably engage a complementary terminal—e.g., 25, 35, 45 and 55—in order to connect one end of the cable 11 to another device. In the preferred embodiment, each of the terminals described throughout this document can be identical and can include the same power ratings as the cable to which they are secured. One suitable example of terminals for use with the above noted cable includes the model SB50 Quick Connect Plugs that are commercially available by Anderson Power Products® having a heavy duty contact amp rating of 50 amps at 600 volts; however, any number of other types of terminals or electrical connectors are also contemplated.

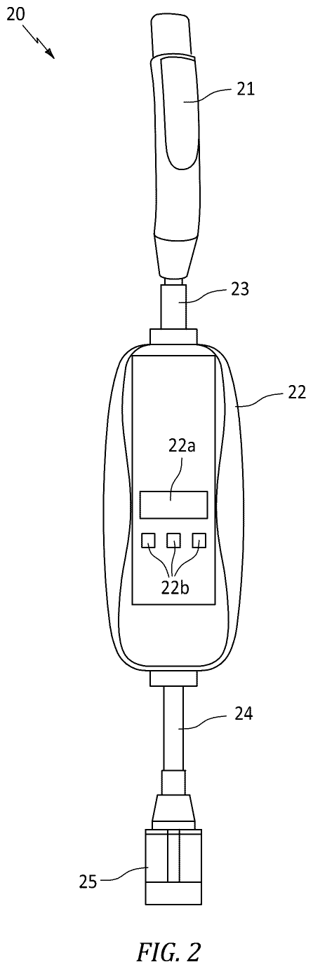

The vehicle charging connector 20 can function to engage and charge an electric vehicle. As shown at FIG. 2, the vehicle charging connector 20 can include a vehicle charging plug 21, and a control panel 22 that is connected to a quick connect terminal 25. As described herein, the charging plug 21 can include any number of different shapes and sizes suitable for engaging the vehicle inlet charging port of a specific electric vehicle such as Tesla®, Ford®, or Chevrolet®, for example, as are known in the art.

The control panel 22 can be positioned between the charging plug 21 and a quick connect terminal 25 via cables 23 and 24, respectively. In one embodiment, the control panel 22 can include a display 22a for showing the operating status of the device and/or the available voltage or amperage being supplied. In one embodiment, one or more buttons 22b may be provided for allowing a user to adjust the power output and to selectively start and stop a charging procedure at the vehicle.

Although not illustrated, the control panel can include any number of internally located charging circuits, surge protection devices, undercharging prevention circuits and sensors, along with a rectifier, as are known in the art to permit safe and continuous charging to the vehicle by the system 10 to conduct industry standard level 2 fast charging of the vehicle.

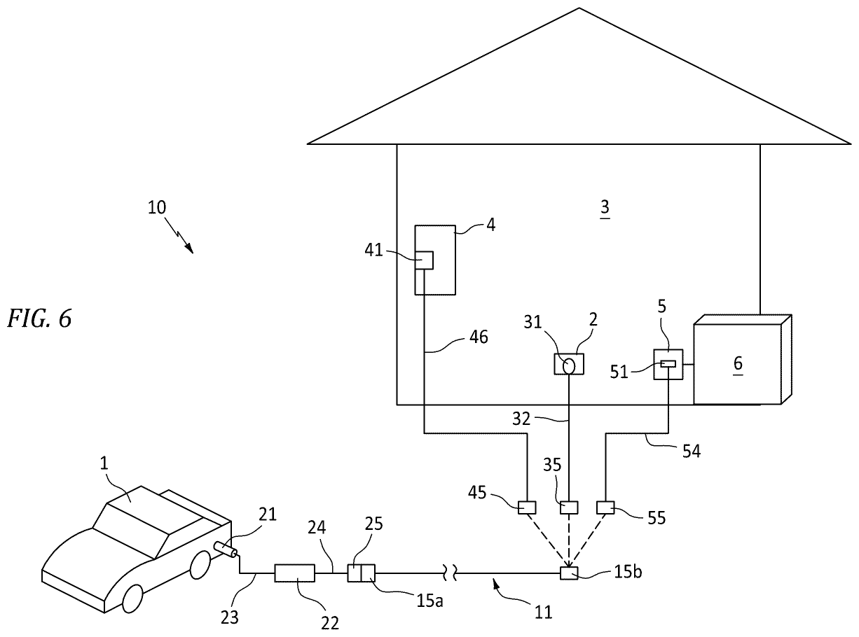

In operation, the terminal 25 of the charging connector can be connected to the first terminal 15a of the charging cable 11, and the charging plug 21 can be connected to the vehicle inlet port of an electric vehicle 1. When so positioned, the user can then connect the terminal 15b in the second end of the cable 11 to one of the terminals 35, 45 or 55 to receive power sufficient to conduct high voltage charging of the vehicle (See FIG. 6).

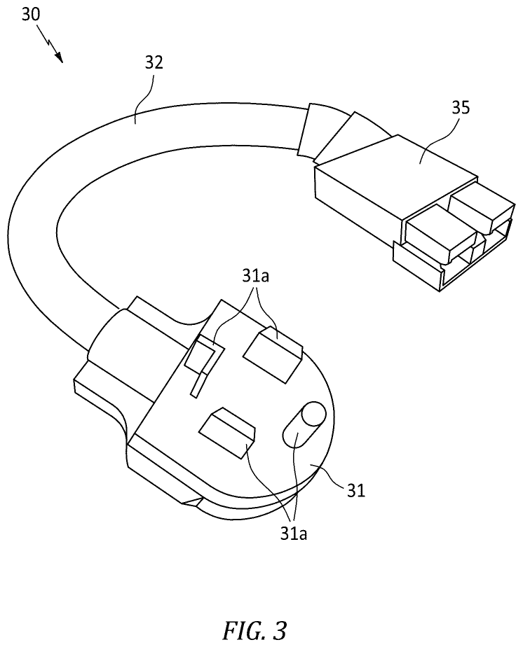

FIG. 3 illustrates one embodiment of a dryer plug power adapter 30 for use with the system 10. In the present embodiment, the adapter 30 can include a plug 31, a cable 32 and a quick connect terminal 35. As described herein, the plug 31 can include a main body having either three or four prongs 31a for engaging the slots of a homes electric dryer outlet which provides an electrical output of 240 volts at 30 amps, as governed by the National Electric Code (NEC).

In operation, the plug 31 can be connected to the dryer outlet 2 of a building 3, and the quick connect terminal 35 can be connected to the second quick connect terminal 15b of the charging cable 11 to supply high voltage power to the vehicle charging connector 20 connected to the other end of the charging cable (See FIG. 6).

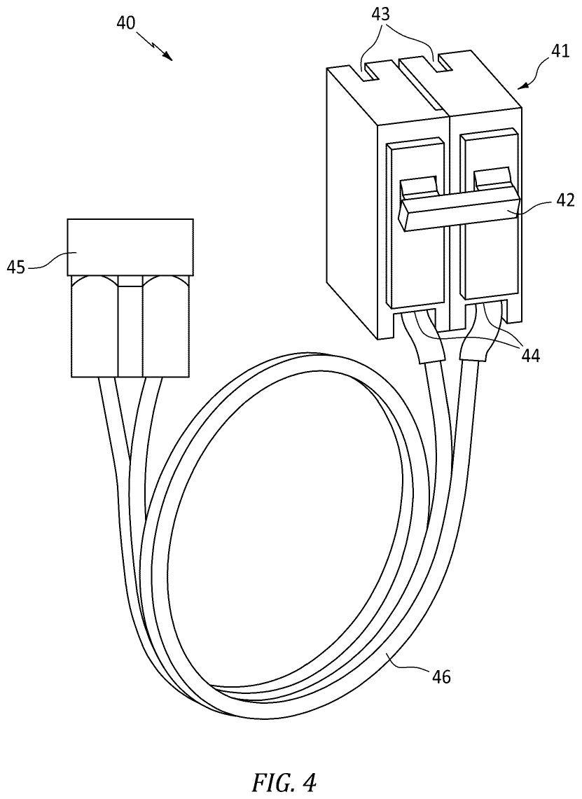

FIG. 4 illustrates one embodiment of a breaker box power adapter 40 for use with the system 10. In the present embodiment, the adapter 40 can include a circuit breaker 41 having an actuator lever 42 along the front end, and one or more busbar clamps 43 which connect to the bus bar(s) of a building's electrical panel/breaker box. A cable 46 is connected to the terminals 44 of the breaker and supplies power to a quick connect terminal 45.

As described herein, the circuit breaker 41 can be sized as a single pole or double pole breaker and can include any number of suitable amperages such as 30 A, 40 A, 50 A or 80 A, among others, for example. The breaker can be shaped and sized so as to be used with any number of commercially available electrical service panels as is known in the art. One example of a commercially available circuit breaker for use herein includes the model Q250 2 pole 50-amp 240v circuit breaker that is commercially available by Siemens®, for example; however any number of other breakers may be utilized herein.

In operation, the circuit breaker 41 can be installed onto an available slot of a building's electrical panel/breaker box 4 in the same way any normal breaker would be installed—e.g., by connecting the busbar clamps to the panel's busbar—as is well known in the art. When so connected, the quick connect terminal 45 can be connected to the second quick connect terminal 15b of the charging cable 11 that is connected to the vehicle charging connector 20. Next, the actuator lever can be engaged to supply high voltage power directly from the breaker box 4 to the vehicle charging connector 20 (See FIG. 6).

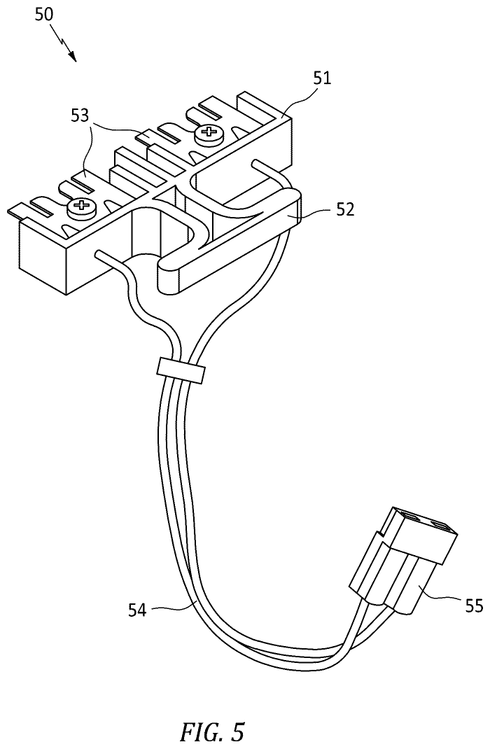

FIG. 5 illustrates one embodiment of an Air Conditioner (AC) power adapter 50 for use with the system 10. In the present embodiment, the adapter 50 can include an AC pullout disconnect switch 51 having a handle 52 along the front end, and a plurality of terminals 53 along the back end for connecting to the AC disconnect box of a buildings air conditioning unit. A cable 54 is connected to the terminals and extends from the front of the adapter to supply power from the disconnect box to a quick connect terminal 55.

As described herein, the pullout disconnect switch 51 can be sized to accommodate any number of different amperages such as 30 A, 40 A, 50 A or 80 A, among others, for example. Likewise, the pullout switch can be shaped and sized so as to be used with any number of commercially available AC disconnect boxes. One example of a commercially available AC disconnect switch and AC disconnect panel includes the model TPN60R1CP 60-amp 240-volt AC disconnect panel and switch by GE®, for example; however any number of other switches may be utilized herein for use with any number of other panels.

In operation, the pullout switch 51 can be installed onto the existing AC disconnect panel 5 of the building's Air Conditioning unit 6 by removing and replacing the existing pullout switch with the switch 51. Next, the quick connect terminal 55 can be connected to the second quick connect terminal 15b of the charging cable 11 that is connected to the vehicle charging connector 20 to supply high voltage power directly from the building's AC disconnect panel to the vehicle charging connector (See FIG. 6).

Although not illustrated, other embodiments of power adapters are contemplated that include a cable having a quick connect terminal along one end, and an adapter for engaging a power source along the other end. To this end, those of skill in the art will recognize that the adapter can include an unlimited number of different shapes, sizes, and connection fittings for engaging virtually any high voltage devices. Accordingly, the inventive concepts are not to be construed as limiting to the specific adapters described herein.

Additionally, although not specifically illustrated, any number of voltage or amperage regulating components may also be provided with the system components. For example, when connecting to a 100-amp power source, a 100 Amp to 50 Amp stepdown adapter can be provided before connecting to the vehicle charging connector 20 to prevent damage to the same.

Accordingly, the inventive system provides a mechanism for allowing electric vehicle owners to conduct high voltage charging at locations where a high voltage charging station is not available.

As to a further description of the manner and use of the present invention, the same should be apparent from the above description. Accordingly, no further discussion relating to the manner of usage and operation will be provided.

As described herein, one or more elements of the device 10 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individually identified elements may be formed together as one or more continuous elements, either through manufacturing processes, such as welding, casting, or molding, or through the use of a singular piece of material milled or machined with the aforementioned components forming identifiable sections thereof.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Likewise, the term “consisting” shall be used to describe only those components identified. In each instance where a device comprises certain elements, it will inherently consist of each of those identified elements as well.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A vehicle charging system, comprising:
a vehicle charging connector that is configured to engage an electric vehicle;
at least one power adapter that is configured to receive power; and
a charging cable that is configured to supply the received power from the power adapter to the vehicle charging connector,
wherein each of the at least one power adapter is removably connected to the charging cable.

2. The device of claim 1, wherein the at least one power adapter includes a first power adapter that is configured to receive power from a first high voltage device, and
said first high voltage device includes at least one of an electric dryer outlet, an electrical panel or an AC disconnect switch.

3. The device of claim 1, wherein the at least one power adapter includes a first power adapter that is configured to receive power from a first high voltage device, and
a second power adapter that is configured to receive power from a second high voltage device,
wherein each of the first and second high voltage devices include at least one of an electric dryer outlet, an electrical panel or an AC disconnect switch.

4. The device of claim 3, wherein the first high voltage device is different from the second high voltage device.

5. The device of claim 1, wherein the at least one power adapter includes a first power adapter that is configured to receive power from a first high voltage device,
a second power adapter that is configured to receive power from a second high voltage device, and
a third power adapter that is configured to receive power from a third high voltage device,
wherein each of the first, the second and the third high voltage devices include at least one of an electric dryer outlet, an electrical panel or an AC disconnect switch.

6. The device of claim 4, wherein the first high voltage device is different from the second high voltage device, and the third high voltage device is different from the first and second high voltage devices.

7. The device of claim 1, wherein the vehicle charging connector includes a vehicle charging plug having a shape and a size that is complementary to a shape and a size of an inlet charging port of the electric vehicle.

8. The device of claim 7, wherein the vehicle charging connector includes a control panel for controlling a charging operation of the charging plug.

9. The device of claim 8, wherein the charging connector is removably connected to the charging cable.

10. The device of claim 1, further comprising:
a first terminal located along a first end of the charging cable, and
a second terminal located along a second end of the charging cable.
